(19) United States
(12) Patent Application Publication
(10) Pub. No.: US 2014/0222478 A1
(43) Pub. Date: Aug. 7, 2014

(54) METHOD AND SYSTEM FOR CREATING AND MANAGING SCHEDULE ON BASIS OF SOCIAL NETWORK

(71) Applicant: BEIJING NETQIN TECHNOLOGY CO., LTD., Beijing (CN)

(72) Inventors: Yanwei Wang, Beijing (CN); Yu Lin, Beijing (CN); Shihong Zou, Beijing (CN)

(21) Appl. No.: 14/129,719

(22) PCT Filed: Oct. 10, 2012
(86) PCT No.: PCT/CN2012/082693

§ 371 Date: Dec. 27, 2013

(30) Foreign Application Priority Data
Oct. 10, 2011 (CN) 201110303608.8

(51) Int. Cl. G06Q 50/00; G06Q 10/06

(52) U.S. Cl. CPC G06Q 50/01; G06Q 10/06311
USPC 705/7.13

(57) ABSTRACT

The present disclosure provides a method and a system for creating and managing a schedule based on a social network. The method comprises the steps of: a schedule management server obtaining information from a specific account of the social network; the schedule management server parsing a type of the information, an identity of an information creator and information content; the schedule management server creating a schedule event based on the parsed type of the information, the identity of the information creator and the information content; and the schedule management server providing a user interface, so that a user views the created schedule event.

### TECHNICAL FIELD

The present application relates to a method and a system for creating and managing a schedule, and in particular, to a method and a system for creating and managing a schedule based on a social network.

### BACKGROUND

A schedule has an important role in lives, more pronounced especially in commercial activities. With the popularity of mobile phones, computers and the like terminals, an electronic schedule has been widely used. How to remotely, quickly and conveniently create and manage a schedule becomes very important.

One existing schedule management solution consists in synchronizing schedule data between a server and a mobile terminal. To be specific, after the schedule data is created at the mobile terminal, the schedule data at the mobile terminal are transmitted to the server through the mobile Internet. When the schedule at the mobile terminal changes, the changed data are transmitted to the server, and therefore the schedule data are kept consistent between the server and the mobile terminal.

Transmission of schedule data among a plurality of mobile terminals needs to depend on transmission of SMS or MMS. A transmitting terminal may compile schedule information into a specific format, or rely on a receiving terminal's semantic analysis function to determine a schedule type SMS, collect schedule information and create a schedule event.

As the above methods use SMS or MMS as a transmission medium, a launching user of a schedule needs to pay SMS or MMS for each participant's schedule notification. If a participant agrees to participate or refuse to participate in reply, SMS or MMS transmission is still needed and fees have to be paid. Therefore, the above method leas to a certain expense burden for users. Moreover, launching an activity is limited to participant(s)'s phone numbers. If an originator does not know a participants phone number, schedule notification could not be achieved.

With the development of the mobile Internet, a social network allows the majority of mobile phone users to contact through the mobile Internet. Social network applications of a mobile terminal include micro-blog or client software of a social network, etc. Micro-blog is a platform for sharing, spreading and obtaining users' concerned information. Through the mobile Internet and various client components, users may update information with a text of about 140 words/characters and share the information in real time. Friends may read information, which is posted by an author, for a short while, and may freely share and discuss with the author. However, the existing micro-blog applications are not incorporated with an electric schedule.

The present disclosure comprehensively solves the problems and shortcomings in the prior art.

### SUMMARY

An object of the present disclosure proposes a method and a system for creating and managing a schedule based on a social network, thereby enabling posting of schedule information and creation and management of a schedule event by utilizing the social network as a carrier. On one hand, the system may provide a user of the social network with a platform for posting schedule information. On the other hand, the system may apply the social network as an information carrier, thereby significantly reducing the user's cost while improving enthusiasm that the user participants in schedule management or discussion.

According to an aspect of the present disclosure, there is provided a method for creating and managing a schedule based on a social network. The method includes the steps of:

a schedule management server obtaining information from a specific account of the social network; the schedule management server parsing type of the information, an identity of an information creator and information content; the schedule management server creating a schedule event based on the parsed type of the information, the identity of the information creator and the information content; and the schedule management server providing a user interface, so as a user logs in and views the created schedule event.

In one embodiment, the social network includes a micro-blog.

In one embodiment, the method for creating and managing the schedule based on the social network further includes the schedule management server regularly obtaining newly posted information from the specific account of the social network.

In one embodiment, the method for creating and managing the schedule based on the social network further includes: the schedule management server judging whether the information creator's account in the social network has been bound with the information creator's account in schedule management server; and if not, sending a prompt to the information creator via the specific account and providing binding related information.

In one embodiment, the method for creating and managing the schedule based on the social network further includes: at a client of the user, providing the user with an interface of entering the schedule information; connecting the client to the social network, so that the user submits the schedule information to a schedule service account of the social network through the client.

In one embodiment, the method for creating and managing the schedule based on the social network further includes the schedule management server synchronizing the created schedule event to the client.

In one embodiment, the method for creating and managing the schedule based on the social network further includes allowing the client or the server to obtain an authorization of the social network, the client or the server obtaining an authorization of the social network authorized includes: the client or the server compiling requirements into a signature and sending the signature to a request token interface of the social network; the client or the server receiving a request token and a request token key from the social network; the client or the server sending the request token and the request token key to an authentication interface of the social network, and the client or the server directing the user to a login page of the social network and inviting the user to authenticate; after the user authenticates, the client or the server obtaining an authorization token and an authorization verification code from the social network; the client or the server sending the authorization token and the authorization verification code to an access interface of the social network; and the client or the server obtaining an access token and an access key from the social network.

According to another aspect of the present disclosure, there is provided a system for creating and managing a schedule based on a social network. The system includes a schedule management server. The schedule management server includes a server communication interface, a parsing module, and a server schedule management module. The schedule management server obtains information from a specific account of the social network through the server communication interface. The parsing module communicates with the server communication interface, obtains schedule information, and parses a type of the information, an identity of an information creator and information content. The schedule management server communicates with the parsing module, and creates a schedule event based on the parsed type of the information, the identity of the information creator and the information content. The schedule management server communicates with the server communication interface, so that a user can log in through the Internet and view the created schedule event.

In one embodiment, the schedule management server regularly obtains newly posted information from the specific account of the social network through the server communication interface.

In one embodiment, the schedule management server further includes a user information management module. The user information management module communicates with the parsing module. The user information management module judges whether the information creator's account in the social network has been bound with the information creator's account in the schedule management server. If not, the user information management module sends a prompt to the information creator via the specific account and provides binding related information.

### BRIEF DESCRIPTION OF THE DRAWINGS

FIG. 1 is a block diagram showing one embodiment of a system for creating and managing a schedule based on a social network according to the present disclosure;

FIG. 2 is a block diagram showing one embodiment of the system for creating and managing a schedule based on a social network according to the present disclosure as shown in FIG. 1;

FIG. 3 is an operational flow chart showing a method for creating and managing a schedule based on a social network according to the present disclosure;

FIG. 4 is a block diagram of another embodiment of the system for creating and managing a schedule based on a social network according to the present disclosure as shown in FIG. 1;

FIG. 5 is an operational flow chart showing another embodiment of a method for creating and managing a schedule based on a social network according to the present disclosure;

FIG. 6 is an operational flow chart of a server or a user obtaining an authorization of a social network; and

FIG. 7 is an exemplary flow chart of one embodiment, in which a user side device exchanges data with a server side device.

### DETAILED DESCRIPTION

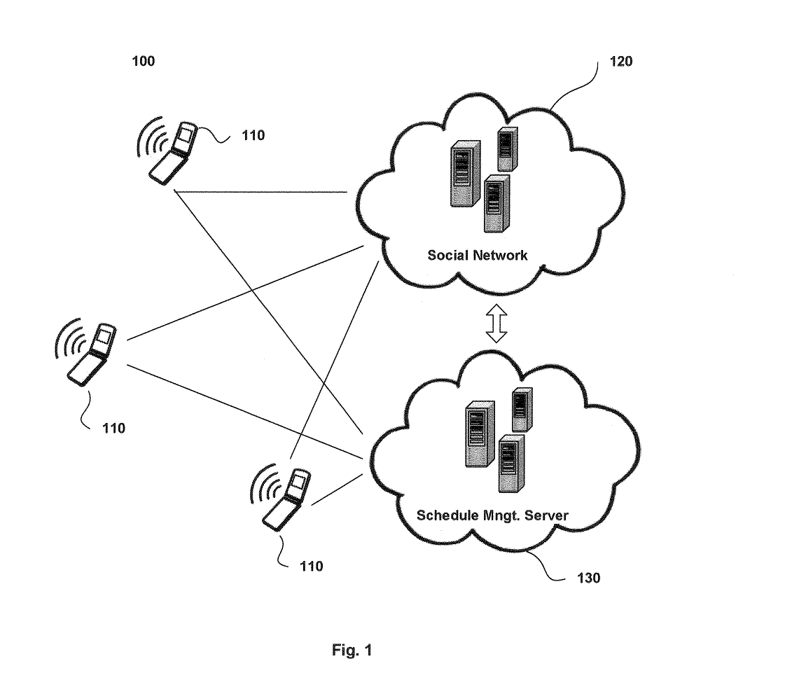

FIG. 1 is a block diagram showing one embodiment of a system for creating and managing a schedule based on a social network according to the present disclosure. The system includes a client 110 and a server 130. The client 110 is installed on a mobile communication device either in a form of software for implementing the following functions of the preset disclosure or in a form of an integrated hardware module for implementing the following functions of the present disclosure. The server 130 is deployed remotely either in a form of software or an integrated hardware module installed on a universal server. The server 130 may communicate with multiple clients 110 and accomplish data processing requirements of the multiple clients 110 by means of cloud computing. Moreover, the server 130 and the multiple clients 110 may also communicate with a social network 120 and submit/receive information to/from the social network 120. Communications among the client 110, the social network 120, and the server 130 may be achieved by using 2G or 3G cellular mobile communication technologies, including, but not limited to, e.g., GPRS, CDMA1X, WCDMA, etc. Communications between the server 130 and the social network 120 may be implemented via the TCP/IP protocol.

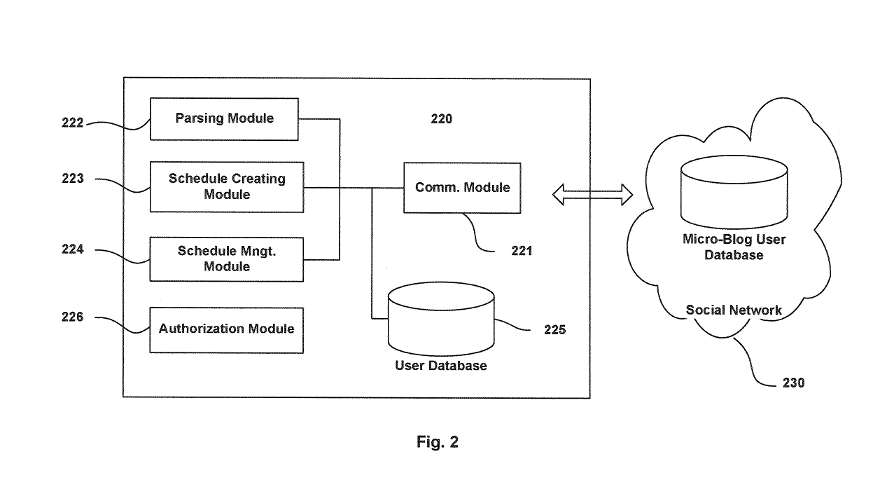

FIG. 2 is a systematic diagram of one embodiment of a system for creating and managing a schedule based on a social network according to the present disclosure.

A server side device 220 includes a communication module 221, a parsing module 222, a schedule creation module 223, a schedule management module 224, a user database 225, and an authorization module 226. The communication module 221 may communicate with server hardware. When the server side device needs to communicate with an external device such as a client device or a social network, the communication module 221 provides an interface of the other party to the server hardware, and transmits or receives compiled data through the server hardware. According to an implementation of the present disclosure, the client device 210 sends schedule information to a specified account of the social network. The specified account is an enterprise account registered by the client device, such as an account of a micro-blog robot. The communication module 221 regularly downloads the schedule information from the specified account of the social network.

The parsing module 222 may communicate with the communication module 221, and receive the schedule information downloaded from the specified account of the social network. The parsing module 222 may parse the received schedule information and classify content of the schedule information. For example, a type of the schedule information may include creation, modification or deletion of a schedule, an ID of a schedule creator, and content, time, location and participants of a schedule event, etc.

According to an implementation of the present disclosure, a schedule format with time and location tags is described as follows:

#Date of Time#, #Location#, [Content of Meeting] @[Account of Netqin's “Robot”] @[Participant 1 of Meeting] @[Participant 2 of Meeting]

The parsing module 222 parses time of a schedule based on a list of the common time input modes. The time may be parsed from a passage through an algorithm. In principle, following the exhaustion principle, the time may be parsed out based on schedule formats listed in the list of time input modes. If there is a schedule format that cannot be parsed, it may be processed according to a default policy.
1. For a schedule format without a time tag, an intelligent matching approach is employed to perform time matching on minutes of meeting inputted by the user, so as to extract date of time from the minutes of meeting as the user's schedule time.
2. For a schedule format with a time tag set by the user, date of time in the time tag is parsed as the user's schedule time.
3. When the first and second parsing approaches cannot exactly parse the user's schedule time, the following rules may be applied:
   1) The date can be accurately parsed, but the time cannot and has to be set according to the current time.
   2) The time can be accurately parsed, but the date cannot and has to be set as the next day of the current date.
   3) Both the date and time cannot be parsed, and then the date and the time are set according to the same time in the next day of the current date.
   4) For 2) and 3), another alternative solution is to record it as notes.
4. The list of time input modes, e.g.

Today, tomorrow, day after tomorrow; in this format, having the current date added 0, 1, and 2 days backward.

This month; in this format, taking the last day of the month.

Next month; in this format, having the date added 30 days backward.

Sep. 16, 2011; Standard Format

2011 Sep. 6; Standard Format

2011 Sep. 6; Standard Format

5 p.m. 17:00

3 o'clock midnight; 3:00 on Current date plus 1backward

5 and a quarter; default 17:15

The schedule creation module 223 may communicate with the parsing module 222 and the user database 225. The schedule creation module 223 receives the classified schedule information from the parsing module 222, and creates a schedule event based on an ID of a schedule creator in the schedule information. The schedule creation module 223 stores the created schedule event into a user account in the user database 225, so that a user may log in and view the schedule information.

The schedule management module 224 may communicate with the parsing module 222 and the user database 225. The schedule management module 224 receives from the parsing module 222 the classified schedule information, such as modification or deletion of a schedule, and schedule attributes, such as an ID of a schedule creator, an ID of a schedule, modification of content, etc.

The authorization module 226 communicates with the social network through the communication module 221. The authorization module 226 compiles requirements of the schedule management server as a signature and transmits the signature to a request token interface of the social network through the communication module 221. The authorization module 226 receives a request token and a request token key from the social network through the communication module 221, transmits the request token and the request token key to an authentication interface of the social network through the communication module 221, and directs the user to a login page of the social network and invites the user to authenticate. After the user authenticates, the authorization module 226 obtains an authorization token and an authorization verification code from the social network through the communication module 221, transmits the authorization token and the authorization verification code to an access interface of the social network through the communication module 221, and obtains an access token and an access key from the social network through the communication module 221.

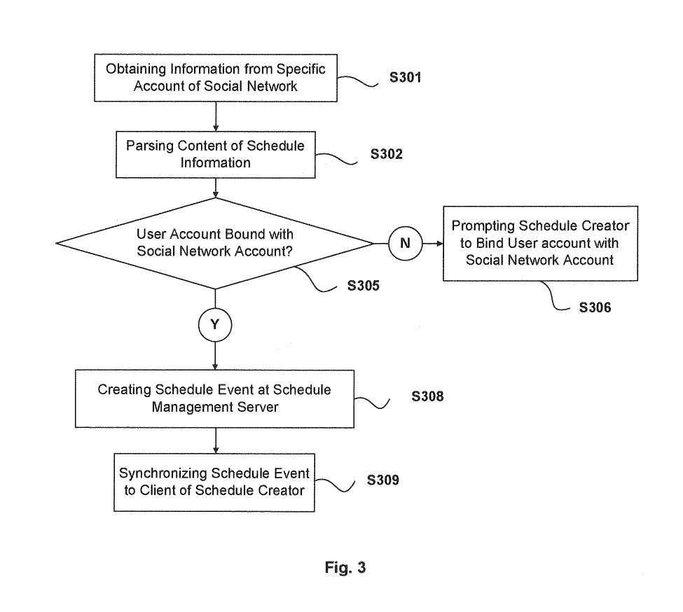

FIG. 3 shows an embodiment of the method for creating and managing the schedule based on the social network according to the present disclosure as shown in FIG. 1. The method for creating and managing the schedule based on the social network starts at step S301 of obtaining information from a specific account of the social network. The specific account is an enterprise account registered by a schedule service provider on the social network, such as “Netqin Schedule.” The server may obtain from the social network information received from the specified account at a predetermined time interval. The predetermined time interval may be of one minute, five minutes or ten minutes.

At step S302, content of the schedule information is parsed. The parsing includes parsing the received schedule information and classifying content of the schedule information. For example, a type of the schedule information may include creation, modification or deletion of a schedule, an ID of a schedule creator, and content, time, location and participants of a schedule event, etc.

At step S305, it is judged whether the schedule creator's account in the schedule management server has been bound with the schedule creator's account in the social network (“a user account” for short). A manner for judging is to view whether there is an access token authorized by the social network stored in a corresponding file folder of the schedule management server. If the user account has not been bound with the account of the social network, at step S306, the schedule creator is prompted to bind the user account with the account of the social network. According to an implementation of the preset disclosure, the user stores his or her mobile phone number, user identity information, or a mobile equipment identity and the like information in his or her account in the schedule management server. A process of binding accounts includes compiling the user information with a user name and an access token of the user in the social network as a signature file. A manner for compiling may include SHA-1 coding or the other equivalent coding schemes.

If the user account has been bound with the account of the social network, at step S308, a schedule event is created at the schedule management server. The created schedule event includes time, location, participants and the like information.

At step S309, the schedule event is synchronized to a client of the schedule creator. According to an implementation of the present disclosure, the system for creating and managing the schedule based on the social network further includes a client, which may be arranged at the user's mobile device, such as a mobile phone. The server may synchronize the created schedule information to the client of the schedule creator through the communication module 221 in TCP/IP or the other common communication manners. To this end, the user can master his or her schedule all the time.

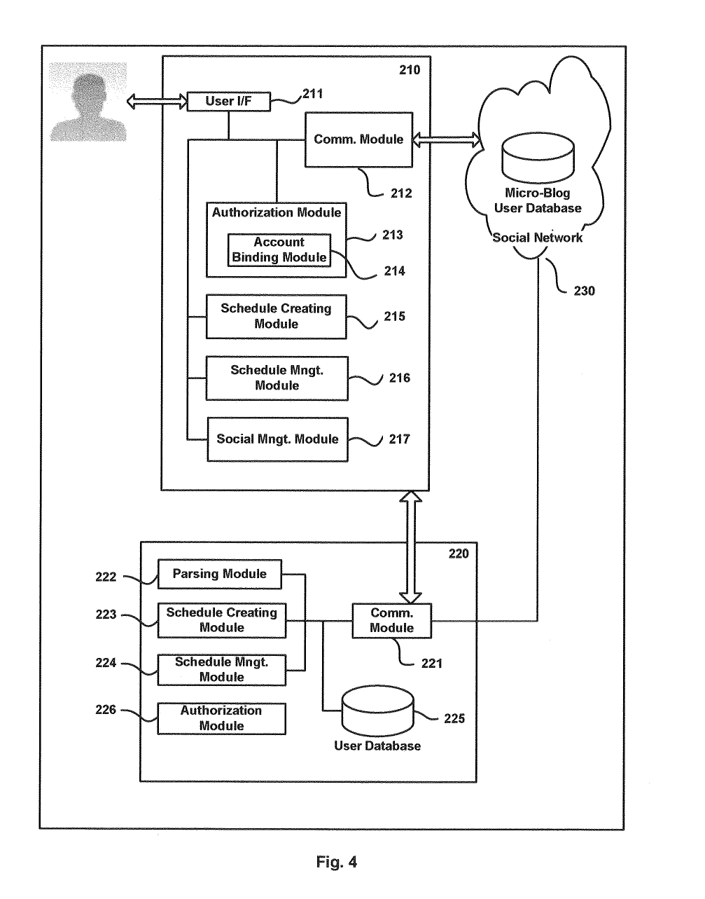

FIG. 4 is a systematic diagram of one embodiment of a system for creating and managing a schedule based on a social network according to the present disclosure. The system includes a user side device 210 and a server side device 220. The user side device 210 includes a communication module 212, a user interface 211, an authorization module 213, an account binding module 214, a schedule creation module 215, and a schedule management module 216. The user interface 211 may provide a display screen and options for user inputs. For example, the user interface 211 may provide a “Create Schedule” button and a “Share to Micro-blog” button for the user to click. When the user selects to create a schedule, an input box is provided for the user to enter the schedule information, such as a name, time, location content and the like of a schedule event. Moreover, the user interface further provides a list of contacts for the user to select participant(s) of the schedule event.

The communication module 212 may communicate with mobile device hardware. When the client needs to communicate with an external device such as a server or a social network, the communication module 212 provides an interface of the other party to the mobile device hardware, and transmits or receives compiled data through the mobile device hardware.

The authorization module 213 communicates with the social network through the communication module 212. The authorization module 213 compiles requirements of a client into a signature and transmits the signature to a request token interface of the social network through a communication module of the client. The authorization module 213 receives a request token and a request token key from the social network trough the communication module of the client, transmits the request token and the request token key to an authentication interface of the social network trough the communication module of the client, and directs the user to a login page of the social network and invites the user to authenticate. After the user authenticates, the authorization module 213 obtains an authorization token and an authorization verification code trough the communication module of the client, and transmits the authorization token and the authorization verification code to an access interface of the social network trough the communication module of the client. The authorization module 213 obtains an access token and an access key from the social network trough the communication module of the client.

In the following, the social network will be described by using SINA Weibo as an example. It will be appreciated that an authorization for services of other social networks may be also obtained by means of the method of the present disclosure. The following description will focus on a client obtaining an authorization of a user's SINA Weibo account from SINA Weibo, with which the client may be authorized to obtain information on the user's SINA Weibo account, and post and receive blogs through the user's SINA Weibo account.

Based on the same principle, it is also possible to enable a server to obtain an authorization of a specific account's Weibo from SINA Weibo. Using the authorization, a schedule management server may be authorized to obtain SINA Weibo information on the specific account, and post and receive blogs through SINA Weibo of the specific account, etc.

The client's software provider may artificially apply for a key such as “MCD8BKwGdgPHvAuvgvz4EQpqDAtx89grbuNMRd7Eh98” and a user ID such as “GDdmIQH6jhtmLUypg82g” of a client application from SINA Weibo. The authorization module 213 synthesizes other information required by the authorization, such as random strings and callback addresses, and the above key and the user ID into a string, and transmits the string to a specific network interface of the social network, e.g., api.t.sina.com.cn/oauth/request_token, through the communication module 212. Subsequently, the authorization module 213 obtains a request token and a request key from SINA Weibo through the communication module 212. The request token and the request key are also provided in a form of strings. The authorization module 213 transmits the request token and the request key to an authorization interface of SINA Weibo, e.g., api.t.sina.com.cn/oauth/authorize, though the communication module 212. The authorization module 213 receives a request login request and a login address sent back from SINA Weibo through the communication module 212 and controls the communication module 212 to connect to the login address. The authorization module 213 controls the user interface 211 to display a login interface or WAP page for the user to enter login information. The authorization module 213 obtains an authorization token and an authorization verification code from SINA Weibo through the communication module 212. The authorization token and the authorization verification code are also provided in a form of strings. The authorization module 213 generates a string by using the authorization token, the authorization verification code, the key and the user ID corresponding to the client application, and other information, and transmits the generated string to an access request interface, e.g., api.t.sina.com.cn/oauth/access_token, of SINA Weibo through the communication module 212. The authorization module 213 obtains an access token and an access key from SINA Weibo through the communication module 212. The authorization module 213 stores the access token and the access key into a memory of the mobile device. The client 210 can post a message to SINA Weibo by using the key, the user ID, the access token and the access key.

The authorization module 213 includes an account binding module 214, which communicates with mobile device hardware. The account binding module 214 may judge whether the user's client account has been bound to the user's Weibo account. The judgment specifically includes checking whether there are backups for the key, the user ID, the access token and the access key in a specific address in client program. If the user has not completed account binding, the account binding module 214 binds the user's client account with the user's Weibo account. For example, the client's software is “Schedule Manager,” the user ID is A, the key is A Secret, the user's user name in SINA Weibo is B, and the key, the user ID, the access token and the access key are stated above. The account binding module 214 performs an association on the above information, so that after logging in “Schedule Manager,” the user may post a Weibo message such as a Weibo topic without providing a Weibo account or password.

According to an implementation of the present disclosure, a schedule Weibo posted by the user is copied and transmitted to an account of a Weibo robot registered by the client's software provider.

The schedule creation module 215 communicates with the user interface 211 and obtains schedule information entered by the user through the user interface 211. The schedule creation module 215 creates a schedule event based on the schedule information entered by the user. The created schedule event may be viewed through the user interface 211. The schedule event may be presented in a form of a schedule table, via which the user may set a reminder time for the schedule event for himself or herself, for example, one day in advance or twelve hours in advance.

The schedule management module 216 provides the user with parameters for modifying and deleting the created schedule event through the user interface 211. For example, the user may manually edit time, location, participants, content and the like information of a schedule. Moreover, the schedule management module 216 may also receive modification or deletion of a schedule from the server 220 through the communication module 212, and synchronically manage schedule events stored by the client 210.

The client 210 further includes a social management module 217. The social management module 217 obtains the user's information in the social network through the communication module 212 and obtains information on the user's contacts, such as user names of good friends, IDs of blog users of interest, etc. The social management module 217 may also communicate with the user interface 211. When the user selects to share schedules over the social network, the social management module 217 may provide a list of the user's contacts, so that a contact may select participant(s) of a schedule event while sending a message (such as posting a micro-blog) to a social network account of a specified participant.

According to an implementation of the present disclosure, the social management module 217 may also regularly parse a social network message received by the user of the mobile device and judge whether it belongs to a schedule type message based on a format and content of the message. If the message received by the user is a schedule message, the social management module 217 transfers the received schedule type message to the schedule creation module 215, which then creates a schedule event based on the schedule message.

In a system for creating and managing a schedule based on a social network as illustrated in FIG. 4, the server side device 220 includes a communication module 221, a parsing module 222, a schedule creation module 223, a schedule management module 224, a user database 225, and an authorization module 226. The communication module 221 may communicate with server hardware. When the server side device needs to communicate with an external device such as a client device or a social network, the communication module 221 provides an interface of the other party to the server hardware, and transmits or receives compiled data through the server hardware. According to an implementation of the present disclosure, the client device 210 sends schedule information to a specified account of the social network. The specified account is an enterprise account registered by the client device, such as an account of a micro-blog robot. The communication module 221 regularly downloads the schedule information from the specified account of the social network.

The parsing module 222 may communicate with the communication module 221, and receive the schedule information downloaded from the specified account of the social network through the communication module 221. The parsing module 222 may parse the received schedule information and classify content of the schedule information. For example, a type of the information may include creation, modification or deletion of a schedule, an ID of a schedule creator, and content, time, location and participants of a schedule event, etc.

The schedule creation module 223 may communicate with the parsing module 222 and the user database 225. The schedule creation module 223 receives the classified schedule information from the parsing module 222, and creates a schedule event based on the ID of the schedule creator in the schedule information. The schedule creation module 223 stores the created schedule event into a user account in the user database 225, so that the user logs in and views the schedule information.

The schedule management module 224 may communicate with the parsing module 222 and the user database 225. The schedule management module 224 receives the classified schedule information, such as modification or deletion of a schedule, and schedule attributes, such as the ID of the schedule creator, an ID of a schedule, modification of content, etc.

The authorization module 226 communicates with the social network through the communication module 221. The authorization module 226 compiles requirements of the schedule management server as a signature, and transmits the signature to a request token interface of the social network through the communication module 221. The authorization module 226 receives a request token and a request token key from the social network through the communication module 221, transmits the request token and the request token key to an authentication interface of the social network through the communication module 221, and directs the user to a login page of the social network and invites the user to authenticate. After the user authenticates, the authorization module 226 obtains an authorization token and an authorization verification code from the social network through the communication module 221, and transmits the authorization token and the authorization verification code to an access interface of the social network through the communication module 221. The authorization module 226 obtains an access token and an access key from the social network through the communication module 221.

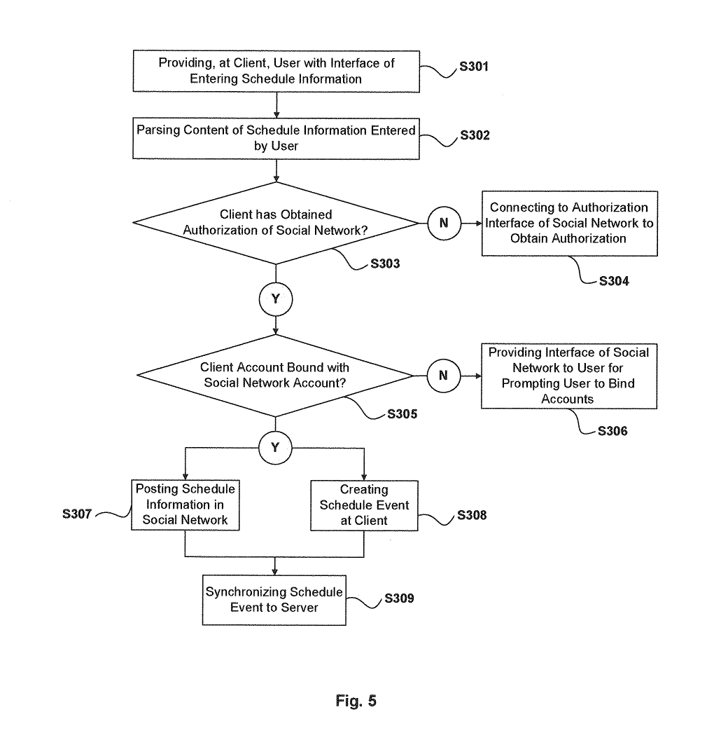

FIG. 5 shows an embodiment of the method for creating and managing the schedule based on the social network according to the present disclosure as shown in FIG. 1. The method for creating and managing the schedule based on the social network starts at step S301 of providing, at a client, the user with an interface of entering schedule information. The interface may provide a display screen and options for user input, such as providing a “Create Schedule” button and a “Share to Micro-blog” button for the user to click. When the user selects to create a schedule, an input box is provided for the user to enter the schedule information, such as a name, time, location content and the like of a schedule event. Moreover, the user interface further provides a list of contacts for the user to select participant(s) of the schedule event.

At step S302, content of the schedule information entered by the user is parsed. The parsing includes parsing the received schedule information and classifying content of the information. For example, a type of the information may include creation, modification or deletion of a schedule, an ID of a schedule creator, and content, time, location and participants of a schedule event, etc.

At step S303, it is judged whether the client has obtained an authorization of the social network. A manner for judging is to view whether there is an access token authorized by the social network stored in a specific file folder related to the social network in a memory of the mobile device.

At step S304, if the client has not obtained the authorization of the social network, the client connects to an authorization interface of the social network to obtain the authorization. If the client has obtained the authorization of the social network, it is judged at step S305 whether the client's account has been bound with an account of the social network. A way for the judgment is to view whether there is an access token authorized by the social network stored in a related file folder in the client's software. If the client's account has not been bound to the account of the social network, at step S306, an interface of the social network is provided to the user for prompting the user to bind the accounts. According to the an implementation of the present disclosure, the user stores his or her mobile phone number, user identity information, or a mobile equipment identity and the like information in the client's account. A process of binding accounts includes compiling the user information with a user name and an access token of the social network as a signature file. A manner for compiling may include SHA-1 coding or the other equivalent coding schemes.

If the user account has been bound with the account of the social network, at step S307, the schedule information is posted in the social network. According to an implementation of the present disclosure, posting the schedule information includes posting the schedule information to a robot account and a participant account. The robot account refers to an enterprise account registered by the client's software provider in the social network. Taking a Chinese blog as an example, assume that the robot's account name is A, the participant's account name is B, a schedule event has a time of a, a location of b and a content of c, then the schedule information may be posted in a form of @ A @ B_a_b_c.

At the same time of posting the schedule information in the social network, at step S308, a schedule event is created at the client. The created schedule event includes time, location, participants and the like information.

Then, at step S309, the schedule event is synchronized to the server. According to an implementation of the present disclosure, the server regularly obtains all the received information from the robot account of the social network. Subsequently, the server parses the received information. The parsing process may include parsing a type of the schedule information, such as creation, modification or deletion of a schedule. The parsing process may further include parsing content of the schedule information, such as an ID of a schedule creator, a schedule event, time, location, participants, etc. The server stores the schedule event in the server based on the parsed schedule information and establishes a network link to access the schedule event, so that the user may log in the server through the Internet and view the schedule.

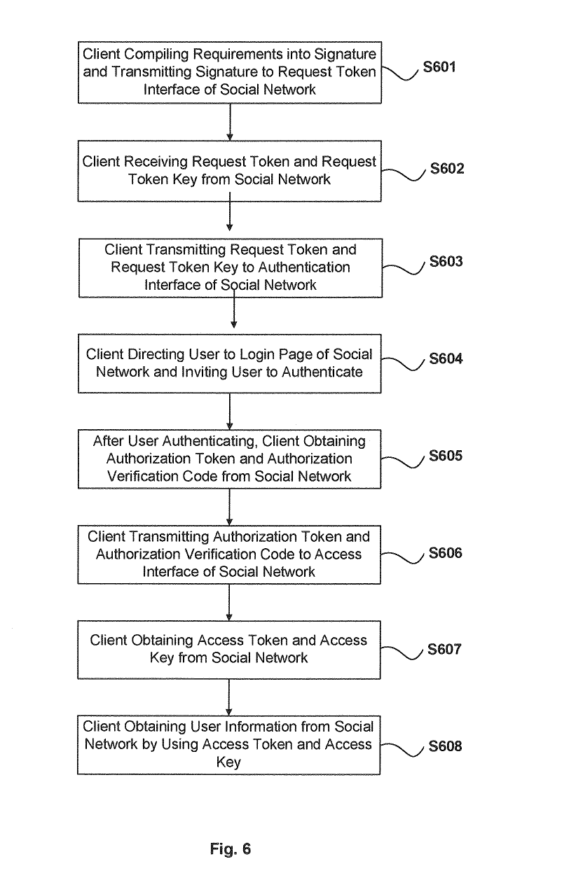

FIG. 6 shows an embodiment of obtaining an authorization of a social network according to step S304 as shown in FIG. 5. At step S601, the client compiles requirements into a signature and sends the signature to a request token interface of the social network. The client's software provider artificially applies for a key and a user ID of a client application from SINA Weibo, and compiles the key and the user ID into the signature. At step S602, the client receives a request token and a request token key from the social network. At step S603, the client transmits the request token and the request token key to an authentication interface of the social network. At step S604, the client directs the user to a login page of the social network and invites the user to authenticate. At step S605, after the user authenticates, the client obtains an authorization token and an authorization verification code from the social network. At step S606, the client transmits the authorization token and the authorization verification code to an access interface of the social network. At step S607, the client obtains an access token and an access key from the social network. At step S608, the client obtains user information from the social network by using the access token and the access key.

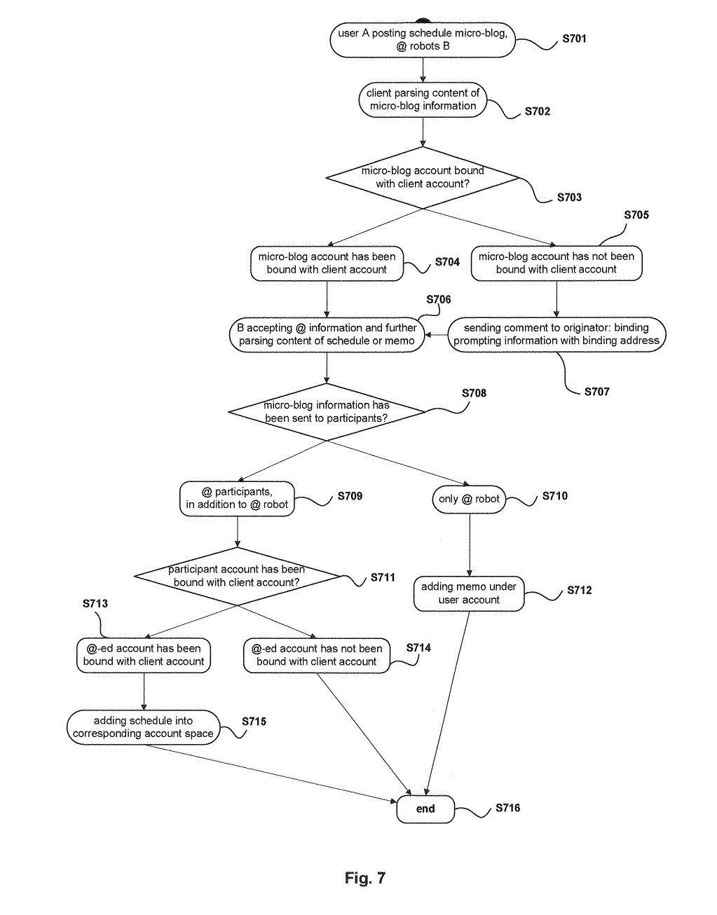

FIG. 7 shows a flow chart of an operation according to an embodiment of the present disclosure. At step S701, a user A posts, at a client, schedule type micro-blog information in a format of, e.g., @ robots B_schedule information. At step S702, the client parses content of the micro-blog information. At step S703, it is judged whether an originator's micro-blog account has been bound with the originator's client account. At step S704, if a result of the judgment is the originator's micro-blog account has been bound with the originator's client account, the operation jumps to step S706, where a robot B accepts the micro-blog information and further parses content of a schedule or memo. At step 705, if the result of the judgment is the originator's micro-blog account has not been bound with the originator's client account, the operation jumps to step S707 of sending an address and prompt information of the bound account to the originator in a form of a micro-blog comment. At step S708, it is judged whether the micro-blog information has been sent to participants based on the parsing result in step S706. At step S710, if the micro-blog information has been only sent to the robot B, the operation jumps to step S712, where a memo is added under the user account. Step S712 may include locally creating a schedule event at the client. At step S709, if the micro-blog information is sent to participants in addition to the robot B, the operation jumps to step S711. At step S711, it is judged whether the participant's micro-blog account has been bound with the participant's client account. At step S713, if a result of the judgment is the participant's micro-blog account has been bound with the participant's client account, the schedule event is added into the participant's server side records. At step S714, if the result is the participant's micro-blog account has not been bound with the participant's client account, the operation jumps to step S716, where the operation ends.

The above mentioned and described embodiments are employed herein to illustrate the principles and the effect of the present disclosure, other than limiting the present disclosure. It will be appreciated by the person of skill in the art that various modifications may be made to the above described embodiments without departing from the scope of the present disclosure. Therefore, the scope of the present disclosure should be recited in the claims.

1. A method for creating and managing a schedule based on a social network, the method includes the steps of:
a schedule management server obtaining information from a specific account of the social network;
the schedule management server parsing a type of the information, an identity of an information creator and information content;
the schedule management server creating a schedule event based on the parsed type of the information, the identity of the information creator and the information content; and
the schedule management server providing a user interface, so that a user views the created schedule event.

2. The method for creating and managing the schedule based on the social network according to claim 1, wherein the social network includes a micro-blog.

3. The method for creating and managing the schedule based on the social network according to claim 1, wherein the schedule management server regularly obtains newly posted information from the specific account of the social network.

4. The method for creating and managing the schedule based on the social network according to claim 1, further comprising:
the schedule management server judging whether the information creator's account in the social network has been bound with the information creator's account in the schedule management server; and if not, sending a prompt to the information creator via the specific account and providing binding related information.

5. The method for creating and managing the schedule based on the social network according to claim 1, further comprising:
at a client of the user, providing the user with an interface of entering the schedule information;
connecting the client to the social network, so that the user submits the schedule information to the specific account of the social network through the client.

6. The method for creating and managing the schedule based on the social network according to claim 5, further comprising:
the schedule management server synchronizing the created schedule event to the client of the user.

7. The method for creating and managing the schedule based on the social network according to claim 4 or 5, further comprising:
allowing the client or the server to obtain an authorization of the social network;
the client or the server obtaining the authorization of the social network comprises:
the client or the server compiling requirements into a signature and sending the signature to a request token interface of the social network;
the client or the server receiving a request token and a request token key from the social network;
the client or the server sending the request token and the request token key to an authentication interface of the social network, and the client or the server directing the user to a login page of the social network and inviting the user to authenticate;
after the user authenticates, the client or the server obtaining an authorization token and an authorization verification code from the social network;
the client or the server sending the authorization token and the authorization verification code to an access interface of the social network; and
the client or the server obtaining an access token and an access key from the social network.

8. A system for creating and managing a schedule based on a social network, the system comprising a schedule management server,
the schedule management server comprises a server communication interface, a parsing module, and a server schedule management module;
the schedule management server obtains information from a specific account of the social network through the server communication interface;
the parsing module communicates with the server communication interface, obtains schedule information, and parses a type of the information, an identity of an information creator and information content;
the schedule management server communicates with the parsing module, and creates a schedule event based on the parsed type of the information, the identity of the information creator and the information content;
the schedule management server communicates with the server communication interface, so that a user logs in through the Internet and views the created schedule event.

9. The system for creating and managing the schedule based on the social network according to claim 8, wherein the schedule management server regularly obtains newly posted information from the specific account of the social network through the server communication interface.

10. The system for creating and managing the schedule based on the social network according to claim 9, further comprising a user information management module,
the user information management module communicates with the parsing module, obtains the identity of the information creator, and judges whether the information creator's account in the social network has been bound with the information creator's account in the schedule management server; if not, the user information management module sends a prompt to the information creator via the specific account and provides binding related information.
